(19) United States
(12) Patent Application Publication
(10) Pub. No.: US 2007/0233655 A1
(43) Pub. Date: Oct. 4, 2007

(54) Graphical program representation of queries

(75) Inventor: Herbert Engels, Austin, TX (US)

Correspondence Address: MEYERTONS, HOOD, KIVLIN, KOWERT & GOETZEL, P.C., P.O. BOX 398, AUSTIN, TX, 78767-0398, US

(73) Assignee: National Instruments Corporation

(21) Appl. No.: 11/396,741

(22) Filed: Apr. 3, 2006

(51) Int. Cl. G06F 17/30

(52) U.S. Cl. 707/3

(57) ABSTRACT

System and method for specifying a graphical query in a graphical program. User input configuring a plurality of nodes and connections between the nodes that specifies a query may be received. The input may be received to a graphical user interface (GUI) and may specify at least a data source and an output for the query. The nodes may include a portion of a graphical data flow program and may indicate data flow among the nodes. In response to the input, the GUI may display one or more options for specifying further characteristics of the query. Further user input specifying where nodes may specify one or more conditions for the query. Executable code implementing the specified query may be generated in accordance with the user input. Generating executable code may include generating a query in a query language and may also include generating machine code to invoke the language-specific query.

### FIELD OF THE INVENTION

The present invention relates to the field of graphical programming, and more particularly to a system and method for creating graphical queries in a graphical program.

### DESCRIPTION OF THE RELATED ART

Traditionally, high level text-based programming languages have been used by programmers in writing application programs. Many different high level text-based programming languages exist, including BASIC, C, C++, Java, FORTRAN, Pascal, COBOL, ADA, APL, etc. Programs written in these high level text-based languages are translated to the machine language level by translators known as compilers or interpreters. The high level text-based programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

To overcome the above shortcomings, various graphical programming environments now exist which allow a user to construct a graphical program or graphical diagram, also referred to as a block diagram. U.S. Pat. Nos. 4,901,221; 4,914,568; 5,291,587; 5,301,301; and 5,301,336; among others, to Kodosky et al disclose a graphical programming environment which enables a user to easily and intuitively create a graphical program. Graphical programming environments such as that disclosed in Kodosky et al can be considered a higher and more intuitive way in which to interact with a computer. A graphically based programming environment can be represented at a level above text-based high level programming languages such as C, Basic, Java, etc.

A user may assemble a graphical program by selecting various icons or nodes which represent desired functionality, and then connecting the nodes together to create the program. The nodes or icons may be connected by lines representing data flow between the nodes, control flow, or execution flow. Thus the block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

A graphical program may have a graphical user interface. For example, in creating a graphical program, a user may create a front panel or user interface panel. The front panel may include various graphical user interface elements or front panel objects, such as user interface controls and/or indicators, that represent or display the respective input and output that will be used by the graphical program, and may include other icons which represent devices being controlled.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

In parallel with the development of the graphical programming model, the use of databases to manage large amounts of data stored in centralized locations has increased dramatically. In these systems, queries are submitted to a database for retrieving and/or otherwise modifying information stored in the database. Queries have been made in various forms and languages, including the structured query language (SQL), XPath and XQuery, for queries in eXtensible Markup Language (XML), the common query language, and others. In general, similar to above, users are required to textually type out query code to be executed by a database server, and are thus required to know the syntax and structure of the particular query language used by the database server and/or the data source from which the information is being retrieved and/or modified. In some cases, the user may need to access information from a variety of sources in a variety of languages, requiring that the user understand the syntax for each of the particular query language in the variety of sources. Thus, improvements in query specification are desirable.

### SUMMARY OF THE INVENTION

Various embodiments of a system and method for creating queries in a graphical program are presented herein. The method may receive first user input creating a graphical program, e.g., using a graphical user interface (GUI) of a graphical program development environment. The user input may comprise configuring a first plurality of nodes and connections between the nodes, wherein the first plurality of connected nodes specify a query. The user may select nodes from the graphical program development environment and include them in the graphical program. The user may also configure certain nodes to perform specific query related functionality. The user may connect the nodes in various manners. For example, the user may create a graphical data flow program where the connections between nodes indicate data flow among the nodes. The user input may specify at least a data source and an output for the query. Additionally, the GUI may automatically display one or more options based on the user input, and the user may subsequently choose among those options to specify further characteristics of the query.

In some embodiments, conditions may be specified by the user. For example, user input, may configure one or more nodes, e.g., one or more where nodes, that graphically represent one or more conditions, e.g., compound conditions, of the query. Consequently, the GUI may populate and display one or more lists corresponding to the one or more nodes and/or the data source. For example, the user may choose and arrange a where node in the query, and subsequently configure the where node. In one embodiment, the user may choose the where node, e.g., by clicking on the node with a mouse, and a list of available variables may be automatically populated and displayed, e.g., one retrieved from the data source. Subsequently, the user may choose one of the variables as well as a conditional for that variable, e.g., equal to, greater than, maximum, minimum, less than, contains, not contains, starts with, not equal to, etc. In one embodiment, the user may then choose a value to compare with the value of the variable, e.g., via the conditional.

In some embodiments, the user may specify an arrangement of the conditions via arranging the plurality nodes representing the query conditions. In one embodiment, the arrangement may include one or more logical operation nodes, e.g., one or more of an OR node, a XOR node, a NOR node, an XNOR node, an AND node, NAND node, and a NOT node. Alternatively, or additionally, the queries may be arranged in a serial fashion and/or a parallel fashion to represent AND and/or OR logical operations respectively.

Thus, the user may specify the query by configuring a plurality of nodes and interconnections between the nodes.

Executable code implementing the specified query may be generated in accordance with the user input, e.g., user input specifying conditions, options, characteristics, and/or functionality of the query as described above. In some embodiments generating the executable code may include generating machine code to perform or implement the specified query. Alternatively, or additionally, generating the executable code may include generating a query in a query language, and generating machine code to invoke the language-specific query.

Alternatively, the user may specify the query using a higher level graphical user interface, e.g., by selecting query parameters in various GUI elements, and a graphical program implementing the query may be automatically generated according to this higher level input. The graphical program that implements a query may be displayed on a display.

The method may also include executing the graphical program and correspondingly, executing the specified query. Thus, the query, e.g., in the graphical program, may execute according to the user input. In other words, at runtime, e.g., as part of the graphical program execution, the specified query may be invoked and/or executed to access the specified data source, e.g., to retrieve and/or modify data stored therein.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a computer system operable to execute a graphical program, according to an embodiment of the present invention;

FIG. 1B illustrates a network system comprising two or more computer systems that may implement an embodiment of the present invention;

FIG. 2A illustrates an instrumentation control system, according to one embodiment of the invention;

FIG. 2B illustrates an industrial automation system, according to one embodiment of the invention;

FIG. 3 is a flowchart diagram illustrating one embodiment of a method for specifying queries in a graphical program, according to one embodiment of the invention;

FIG. 4 illustrates an exemplary query, according to one embodiment of the invention;

FIGS. 5A and 5B illustrate two exemplary queries with differing data sources and outputs, according to one embodiment of the invention;

FIG. 6 illustrates an exemplary front panel for displaying the result of the query, according to one embodiment of the invention;

FIG. 7A illustrates an exemplary window for connecting an external data source, according to one embodiment of the invention;

FIG. 7B illustrates exemplary underlying information, according to one embodiment of the invention;

FIG. 8 illustrates an exemplary compilation of a graphical query, according to one embodiment of the invention;

FIGS. 9A-9G illustrate an exemplary query specification, according to one embodiment of the invention;

FIG. 10 is a flowchart diagram illustrating one embodiment of a method for specifying queries in a graphical program, according to one embodiment of the invention.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Patent Application Publication No. 20010020291 (Ser. No. 09/745,023) titled “System and Method for Programmatically Generating a Graphical Program in Response to Program Information,” filed Dec. 20, 2000.

U.S. patent application Ser. No. 09/886,455 titled “System and Method for Programmatically Generating a Graphical Program in Response to User Input,” filed Jun. 20, 2001.

U.S. patent application Ser. No. 09/518,492 titled “System and Method for Programmatically Creating a Graphical Program,” filed May 3, 2000.

Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a physical communication medium such as a bus, network and/or other physical transmission medium.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium and/or a programmable hardware element; encompasses various types of mediums that can either store program instructions/data structures or can be configured with a hardware configuration program. For example, a medium that is “configured to perform a function or implement a software object” may be 1) a memory medium or carrier medium that stores program instructions, such that the program instructions are executable by a processor to perform the function or implement the software object; 2) a medium carrying signals that are involved with performing the function or implementing the software object; and/or 3) a programmable hardware element configured with a hardware configuration program to perform the function or implement the software object.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW, DasyLab, DIAdem and Matrixx/SystemBuild from National Instruments, Simulink from the MathWorks, VEE from Agilent, WiT from Coreco, Vision Program Manager from PPT Vision, SoftWIRE from Measurement Computing, Sanscript from Northwoods Software, Khoros from Khoral Research, SnapMaster from HEM Data, VisSim from Visual Solutions, ObjectBench by SES (Scientific and Engineering Software), and VisiDAQ from Advantech, among others.

The term “graphical program” includes models or block diagrams created in graphical modeling environments, wherein the model or block diagram comprises interconnected nodes or icons that visually indicate operation of the model or block diagram; exemplary graphical modeling environments include Simulink, SystemBuild, VisSim, Hypersignal Block Diagram, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected nodes are often referred to as the block diagram portion of the graphical program.

Node—In the context of a graphical program, an element that may be included in a graphical program. A node may have an associated icon that represents the node in the graphical program, as well as underlying code or data that implements functionality of the node. Exemplary nodes include function nodes, terminal nodes, structure nodes, etc. Nodes may be connected together in a graphical program by connection icons or wires.

Data Flow Graphical Program (or Data Flow Diagram)—A graphical program or diagram comprising a plurality of interconnected nodes, wherein the connections between the nodes indicate that data produced by one node is used by another node.

Graphical User Interface—this term is intended to have the full breadth of its ordinary meaning. The term “Graphical User Interface” is often abbreviated to “GUT”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators

Input Control—a graphical user interface element for providing user input to a program. An input control displays the value input the by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

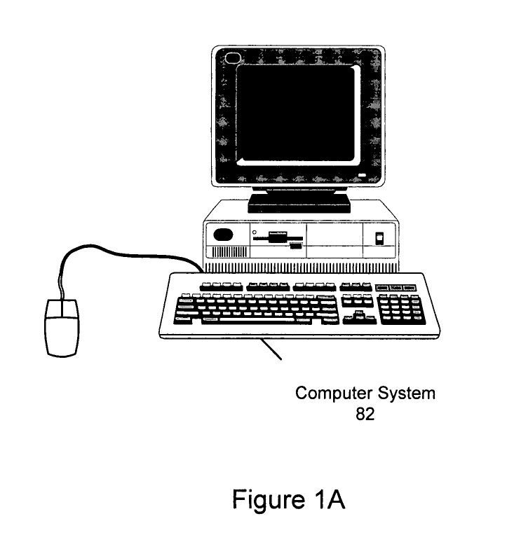

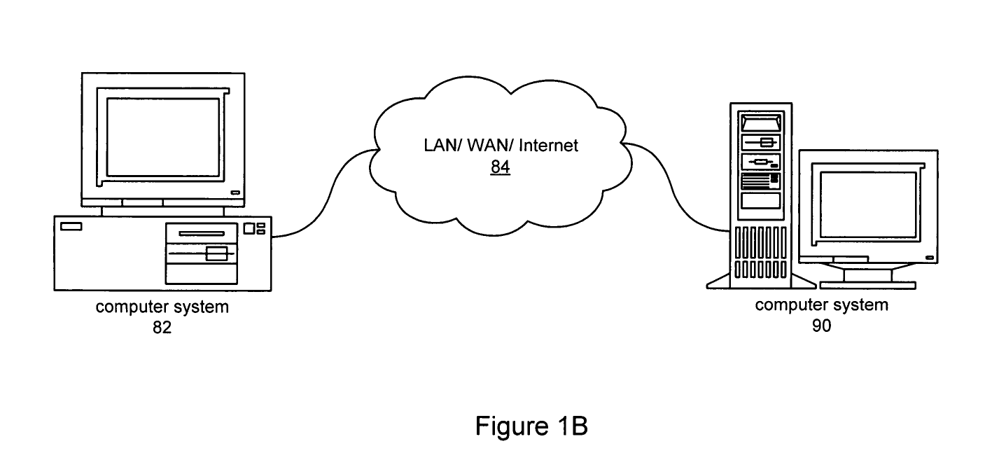

FIG. 1A—Computer System

FIG. 1A illustrates a computer system 82 operable to receive user input configuring a query in a graphical program. One embodiment of a method for creating a query in a graphical program is described below.

As shown in FIG. 1A, the computer system 82 may include a display device operable to display the graphical program as the graphical program is created and/or executed. The display device may also be operable to display a graphical user interface or front panel of the graphical program during execution of the graphical program. The graphical user interface may comprise any type of graphical user interface, e.g., depending on the computing platform.

The computer system 82 may include at least one memory medium on which one or more computer programs or software components according to one embodiment of the present invention may be stored. For example, the memory medium may store one or more graphical programs. Additionally, the memory medium may store a graphical programming development environment application used to create and/or execute the graphical programs. The memory medium may also store operating system software, as well as other software for operation of the computer system. Various embodiments further include receiving or storing instructions and/or data implemented in accordance with the foregoing description upon a carrier medium.

FIG. 1B—Computer Network

FIG. 1B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute a graphical program in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program. Alternatively, or additionally, the computer system 90 may store one or more files or databases which may be queried by a graphical program executing on the computer system 82.

In one embodiment, the graphical user interface of the graphical program may be displayed on a display device of the computer system 82, and the block diagram may execute on a device coupled to the computer system 82. The device may include a programmable hardware element and/or may include a processor and memory medium which may execute a real time operating system. In one embodiment, the graphical program may be downloaded and executed on the device. For example, an application development environment with which the graphical program is associated may provide support for downloading a graphical program for execution on the device in a real time system.

Exemplary Systems

Embodiments of the present invention may be involved with specifying queries using a graphical programming metaphor in any of various types of application domains. One example may comprise specifying a database query using a graphical program implementation. Other examples may comprise using a graphical programming environment to specify a query for test, measurement, and/or simulation data, which may be stored in a database or in another storage format.

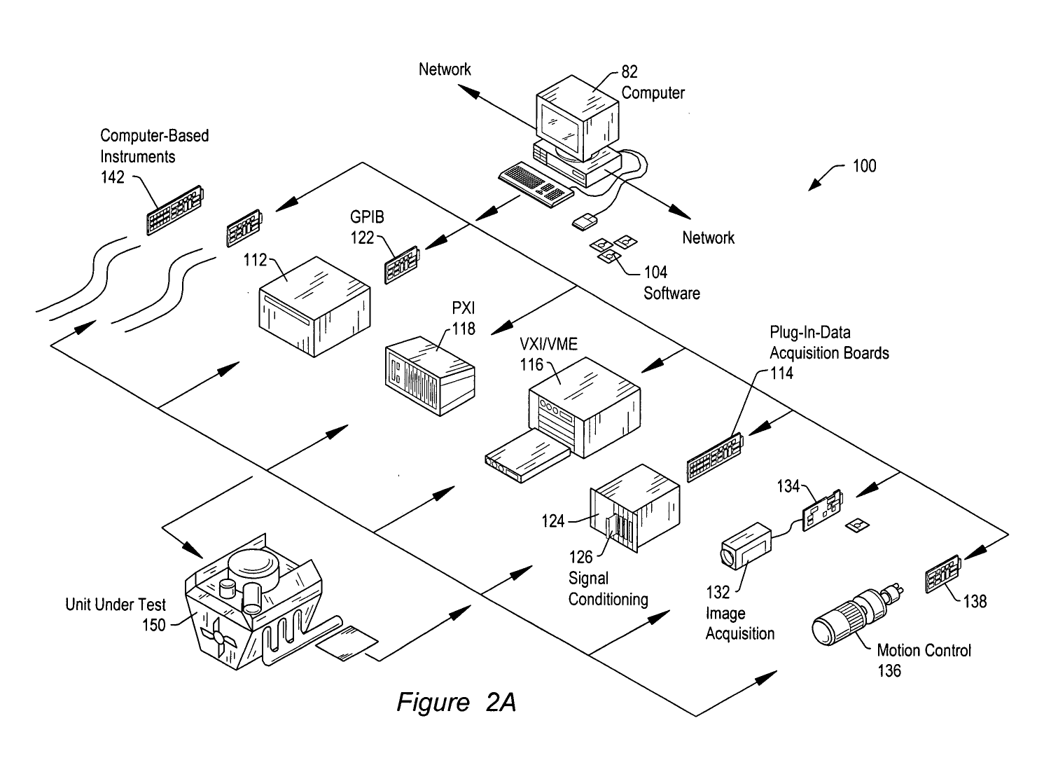

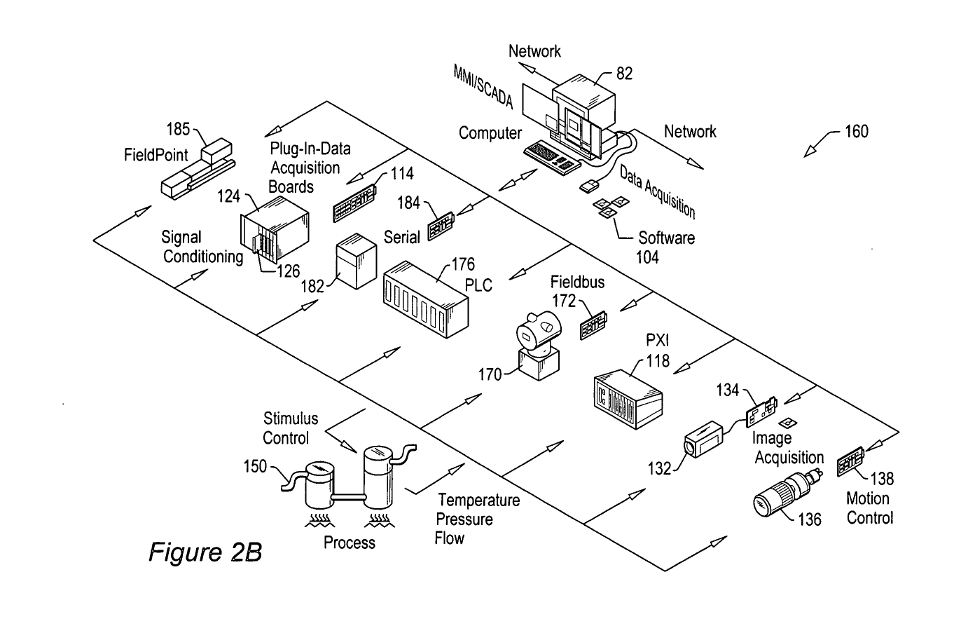

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

In the embodiments of FIGS. 2A and 2B above, one or more of the various devices may acquire data which is stored on a memory medium, such as in a database. Alternatively, or in addition, a program executing on the computer 82 may analyze acquired data and store the results on a memory medium, such as in a database. The user may specify a query using a graphical programming development environment to request a subset of the data. In other words, the user may specify a query by selecting and configuring graphical program nodes, as well as connections between the nodes, to form part of a graphical program, as discussed further below.

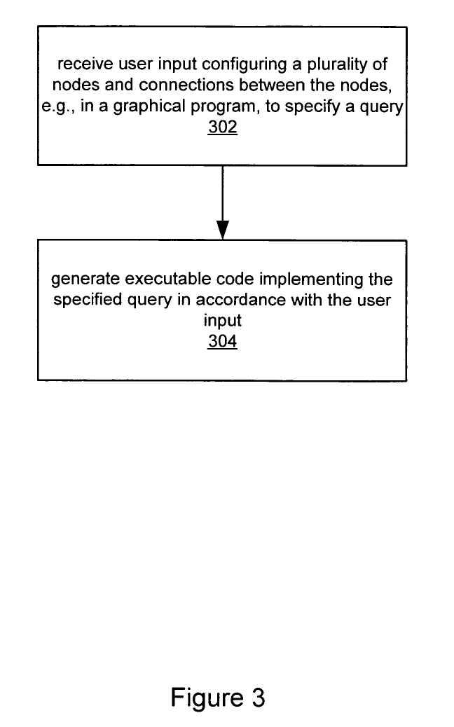

FIG. 3—Method for Specifying Queries in a Graphical Program

FIG. 3 illustrates an exemplary method for specifying queries in a graphical program. The method shown in FIG. 3 may be used in conjunction with any of the computer systems or devices shown in the above Figures, among other systems or devices. In various embodiments, some of the method elements shown may be performed concurrently, in a different order than shown, or may be omitted. Additional method elements may also be performed as desired. As shown, this method may operate as follows.

In 302, first user input configuring at least a portion of a query, e.g., in a graphical program, may be received. In one embodiment, the query may be configured on the computer system 82 (or on a different computer system). The query may be created or assembled by the user arranging on a display a plurality of nodes or icons and then interconnecting the nodes, e.g., using a graphical user interface (GUI), e.g., to create a first portion of the graphical program. The nodes may be interconnected in one or more of a data flow, control flow, or execution flow format. The query may thus comprise a plurality of interconnected nodes or icons which visually indicates the functionality of the query.

In one embodiment, the user may use a graphical program development environment to create the query in the graphical program. Exemplary graphical program development environments include LabVIEW, Simulink and other similar environments for creating graphical programs. The graphical program development environment may comprise a selection of nodes for inclusion in the graphical program. The selection may comprise a menu of nodes, a hierarchical listing, one or more palettes, etc. The user may select nodes which implement a portion (or all) of the query and place them in a graphical program window, e.g., a block diagram window.

The user may configure individual nodes, e.g., by selecting a node for configuration (e.g., by right clicking on the node or other user input). This may cause to appear a dialog box with user configurable parameters for configuring the node. The user may then enter or modify various parameters to set desired operation of the particular node.

The user may connect the nodes together as part of configuring the functionality of the graphical program. The user may connect graphical program nodes in any of various ways. For example, the user may use a mouse to select an output port of a first node and drag the mouse over to an input port of a second node to create the connection. Alternatively, the user may use a “wiring tool” (an icon) to create connections between nodes. In a data flow graphical program, the connections between the nodes may indicate data produced by one node is used by another node. For example, the connections between nodes may specify data dependencies among the nodes.

A graphical program including the query and/or the query itself may include a block diagram as well as a user interface portion or front panel portion. Where the graphical program and/or query includes a front panel portion, the user may optionally assemble the front panel portion on the display. As one example, the user may use the LabVIEW graphical programming development environment to create the query in the graphical program. As indicated in descriptions regarding earlier Figures, the graphical program may be operable to perform any of various functions including, but not limited to, one or more of an industrial automation function, a process control function, a test function, and a measurement function, among others.

In one embodiment, the first user, input may specify a query type, i.e., of the specified query. For example, the query type may include one or more of fetch, e.g., to retrieve information from a data source, delete, e.g., to delete information in the data source, count, e.g., to return the number of items matching the condition, sum, e.g., to sum the items, multiply, e.g., to multiply the items, divide, e.g., to the divide the items update, e.g., to modify one or more of the items, average, e.g., to return a mean value of the items, minimum, and/or maximum, e.g., of a set of the items, among others.

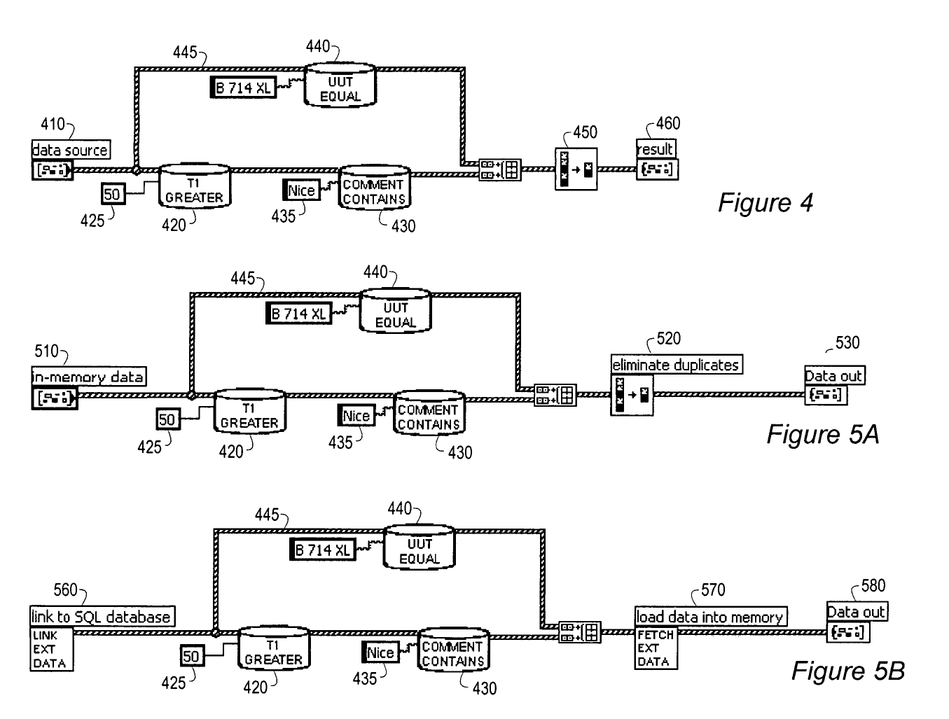

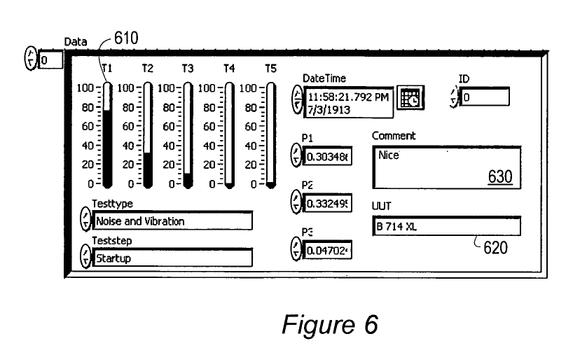

In some embodiments, the first user input may specify at least the data source and an output for the query as illustrated in FIGS. 4, 5A, and 5B. FIG. 4 illustrates an exemplary query with a generic data source 410 and a generic output, e.g., result 460. In one embodiment, the data source and/or output may include one or more of: a memory medium comprised in a computer executing the GUI, e.g., the computer system 82, a memory medium coupled to the computer executing the GUI, e.g., the computer system 90, a database, a structured query language (SQL) database, an external file, a mark-up language file, e.g., an eXtensible Markup Language file (XML), an array, and a Technical Data Management (TDM) file. Further details of such graphical queries are provided below.

FIGS. 5A and 5B illustrate two queries with different data sources. For example, in FIG. 5A, 510 labels a specified “in memory” source, e.g., the memory medium included in the computer executing the GUI, e.g., the computer system 82, and the output is specified as data out node 530. In this example, “eliminate duplicates” node 520 (and node 450) specifies that data retrieved from the memory medium only be stored and/or displayed once per unique item and/or data set in the memory medium, i.e., no duplicate items per query return. In various embodiments, the query may be specified as a SQL query, e.g., when the source is a SQL database, as an XPath query, e.g., when the source is a TDM file, and/or other appropriate query types.

FIG. 5B illustrates an exemplary SQL query specified in a graphical program. More specifically, FIG. 5B illustrates an exemplary SQL query, including SQL database data source node 560, and data out node 580. Note that the query illustrated in FIG. 5B includes the query type fetch, as indicated by “fetch external data” node 570.

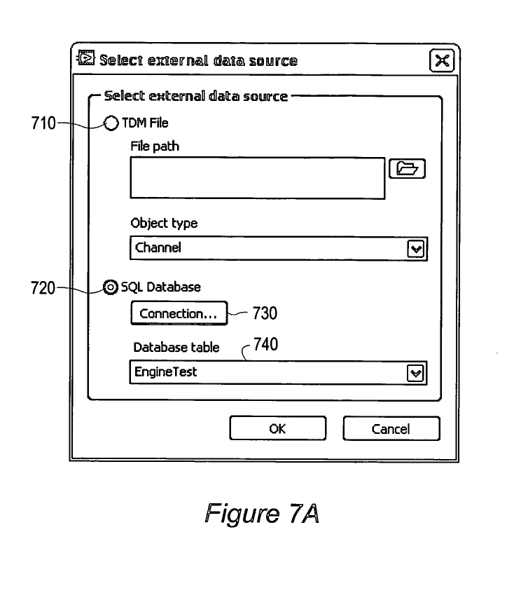

Alternatively, or additionally, the output may include a visual display of the results of the query, e.g., in the front panel portion of the graphical program. FIG. 6 illustrates an exemplary front panel for displaying results of the query, and will be described in more detail below.

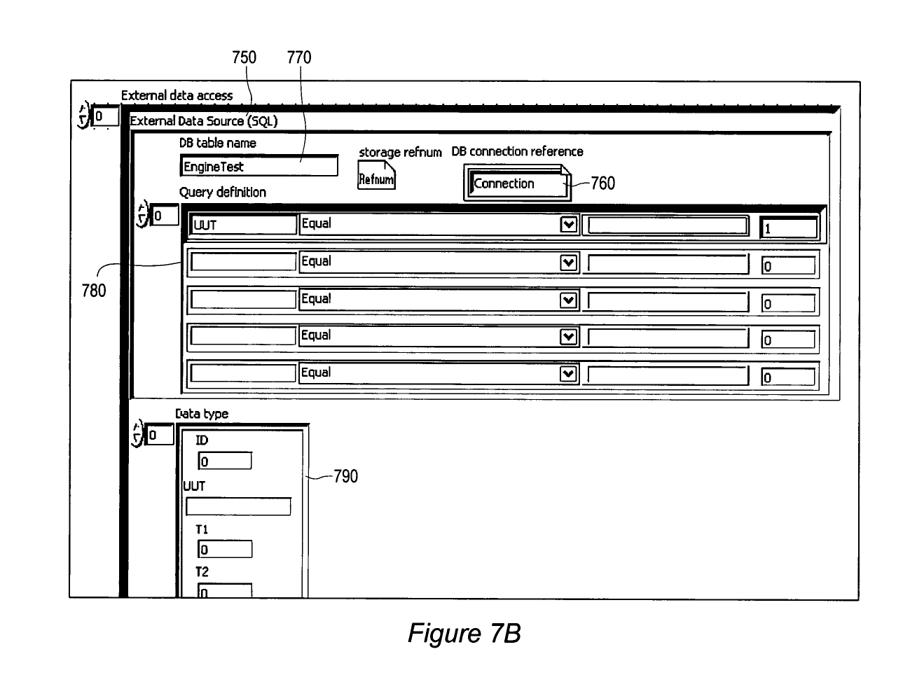

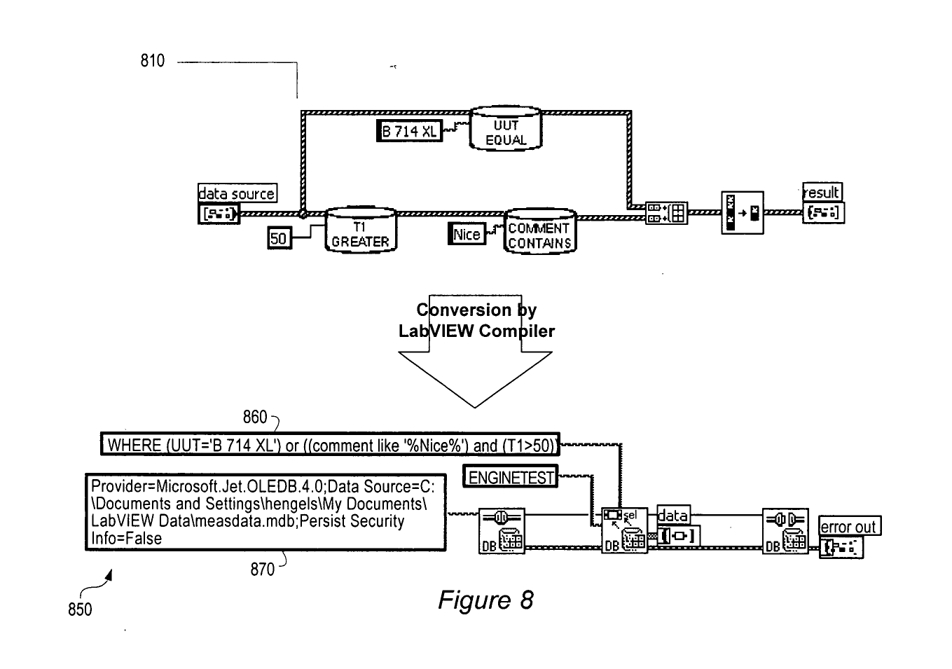

As described above, the first user input is preferably received to or by a GUI. In some embodiments, the GUI may automatically display one or more options based on the first user input, e.g., based on the specified data source or output of the query. For example, the GUI may request further information from the user based on the specified data source, e.g., connection information, e.g., via a presented list of available connections or connection options. For example, if the first user input specifies an external data source, e.g., a database, the GUI may automatically display an external data source connection window or wizard that includes one or more available options for specifying a connection to the data source, in this case, the database. FIG. 7A illustrates an exemplary external data source connection window whereby the user may select or otherwise specify an external data source, e.g., in this case, a TDM file, e.g., via radio button 710, or an external SQL database, e.g., via radio button 720. In the case of the external SQL database, in some embodiments, the user may choose to specify the connection via a connection window and/or wizard, e.g., using connection button 730, and may subsequently choose a database table from that database from a drop-down menu, e.g., via menu 740. Note that the above described connection window is exemplary only, and other windows, wizards, and that external data sources are envisioned, among others.

Alternatively, or additionally, the GUI may guess features and/or characteristics of the query based on contextual information, e.g., from the first user input and/or from other information present in, for example, the graphical program, and provide the user with choices and/or options regarding these features and/or characteristics. For example, in one embodiment, the GUI may automatically choose query variables or conditions for the user, e.g., based on previous user-specified queries or available options from the already specified data source, conditions, output, etc. Thus, the GUI may receive further user input choosing one or more of the automatically displayed options to specify additional features and/or characteristics of the query.

In some embodiments, conditions may be specified by the user. For example, user input, e.g., the first user input or received second user input, may configure one or more nodes, e.g., one or more where nodes, that graphically represent one or more conditions, e.g., compound conditions, of the query. Consequently, the GUI may populate and display one or more lists corresponding to the one or more nodes and/or the data source. For example, the user may choose and arrange a where node in the query, and subsequently configure the where node. In one embodiment, the user may choose the where node, e.g., by clicking on the node with a mouse, and a list of available variables may be automatically populated and displayed, e.g., as retrieved from the data source. Subsequently, the user may choose one of the variables as well as a conditional for that variable, e.g., equal to, greater than, maximum, minimum, less than, contains, not contains, starts with, not equal to, etc. In one embodiment, the user may then choose a value to compare with the value of the variable, e.g., via the conditional. For example, the user may choose the variable T1, e.g., corresponding to a first temperature, from the list of available choices in the data source. The user may then specify that the query only return and/or modify information from the database where the first temperature is above 50 by choosing the “greater than” and specifying the value ‘50’, e.g., via a keyboard coupled to the computer system, e.g., the computer system 82. In one embodiment, the user may specify one or more additional conditions of the query similar to the above method, e.g., via receiving user input, populating one or more lists, receiving user input selecting one or more elements from the one or more lists, and receiving user input specifying one or more values corresponding to the one or more elements.

In some embodiments, the user may specify an arrangement of the conditions via arranging the plurality nodes representing the query conditions. In one embodiment, the arrangement may include one or more logical operation nodes, e.g., one or more of an OR node, a XOR node, a NOR node, an XNOR node, an AND node, NAND node, and a NOT node. Alternatively, or additionally, the queries may be arranged in a serial fashion and/or a parallel fashion to represent AND and/or OR logical operations respectively.

Such an arrangement is illustrated in the exemplary query in FIG. 4. In this query, where nodes 420 and 430 specify two conditions, with corresponding values 425 and 435, specify combination according to an AND operation, i.e., due to serial arrangement, and the results of these two conditions may combine according to an OR operation with the result of the condition as specified by where node 440 and value 445. More specifically, during execution, e.g., after specification of the query as illustrated by FIG. 4, all values retrieved from the data source may be represented before entering any of the conditions, e.g., the where nodes 420, 430, and 440. Following the branch point, a first set of the data, i.e., the lower branch, from the data source may be restricted to those data points, or sets, where T1 is greater than 50, i.e., specified by condition 420, and where the comment contains the word ‘nice’, i.e., specified by condition 430. A second set of data, i.e., the top branch, from the data source may be restricted to those data points or sets where the unit under test (UUT) variable is equal to ‘B 714 XL’, which may be a serial number of a device, or other device specification. As shown, these two data sets may then be merged additively, i.e., according to a logical OR operation, where duplicates, i.e., data points or sets represented from both the first and second data sets, in the resultant data set are eliminated at or by eliminate duplicates node 450, and the final result of the query may be stored or displayed according to result node 460. FIGS. 5A and 5B illustrate similar query arrangements with different data sources, and resultant modifications, as described above.

In some embodiments, the user may be able to view a representation, e.g., an overall representation, of the query, e.g., after specifying the query. For example, the user may be able to view all of the conditions and the query in a different form, e.g., in a tabular format. Additionally, the user may view other information including data formats of the specified variables, connection information, database table information, and others. In one embodiment, the user may use this representation to do future editing of the specified query alternatively, or in addition to editing the plurality of nodes that graphically represent the query. FIG. 7B illustrates an exemplary representation, e.g., in this case, based on the example presented in FIG. 7A. As shown, and as indicated above, the representation may include information regarding the data source, e.g., in this case, external data source (SQL) 750. The representation may also include the connection information, e.g., connection tab 760, DB table name, e.g., engine test 770, the query definition, e.g., in 780, and information regarding the data type, e.g., in 790.

In 304, executable code implementing the specified query may be generated in accordance with the user input, e.g., user input specifying conditions, options, characteristics, and/or functionality of the query as described above. In some embodiments generating the executable code may include generating machine code to perform or implement the specified query. Alternatively, or additionally, generating the executable code may include generating a query in a query language, and generating machine code to invoke the language-specific query.

For example, if the user input specifies a SQL query, generating the executable code may include generating the SQL query and generating code, e.g., machine code, to invoke and/or transmit the SQL query. In some embodiments, the language specific query may be transmitted to a database server, and the database server may perform the query with respect to an external database. Upon performing the query, the database server may transmit the information back to the GUI and/or graphical program for use and/or storage. Following the example above, the database server may be a SQL database server, and the database may be a SQL database. Alternatively, the language-specific query may be an XPath query, the database server may be one or more of a National Instruments DataFinder component, a National Instruments Universal Storage Interface (USI) component, a Xerces component, and/or an internet browser, and the data source may be one or more of a TDM file, an XML file, or an XML-Document Object Model (XML-DOM) file. Note that the above examples, e.g., the query types, the database servers, and/or the data sources, are exemplary only, and other examples, query types, database servers, and data sources are envisioned.

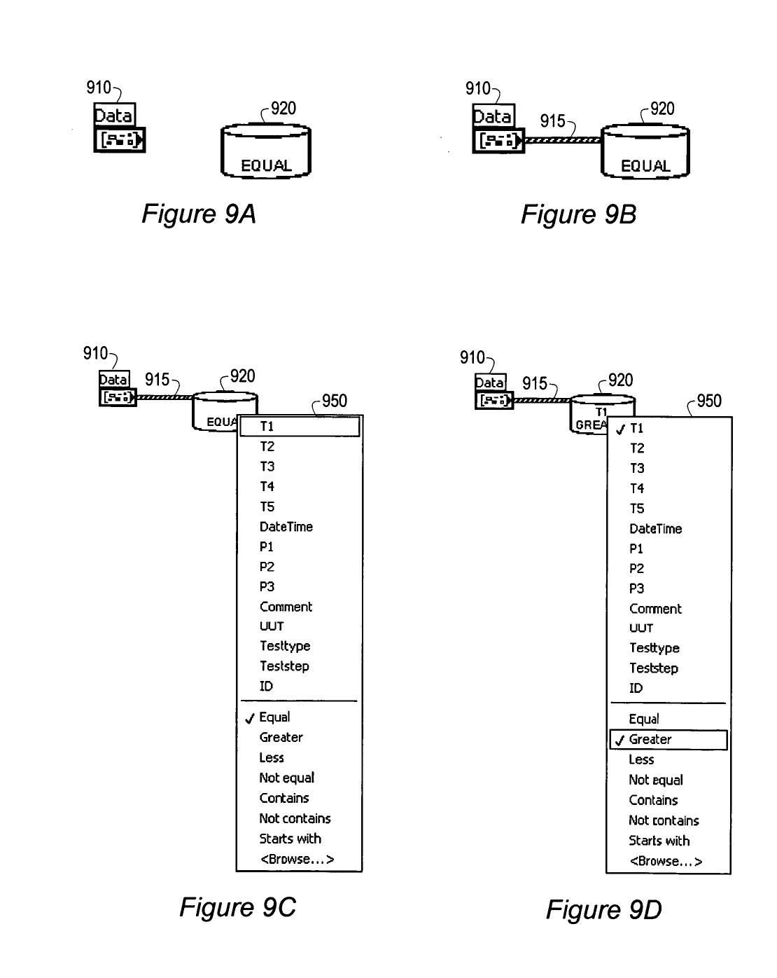

In some embodiments, the executable code may be generated at run-time or during compilation of the program, e.g., the graphical program, including the specified query. FIG. 8 illustrates an exemplary conversion of the query, e.g., in LabVIEW provided by National Instruments Corporation, from the specified graphical format to a format to be used during execution. In this case, from the graphical format represented by query 810 to query code format 850, e.g., conversion of the where nodes described above with respect to FIGS. 4-6, to the text query 860, and corresponding connection info 870

More specifically, in some embodiments, the executable code may be generated during runtime according to the specified query. For example, if the specified query retrieves data from memory, executable code may be generated for each node in the query, e.g., each WHERE node, such that, at run-time, the generated code may be executed for that node. In one embodiment, the machine code generated for each node may at runtime populate a data structure similar to that of FIG. 7B, which may be subsequently transformed into a query language format for execution.

Alternatively, if the specified query retrieves data from an external source, the generated executable code, e.g., machine code, may include the query conditions specified from a plurality of nodes of the query. In some embodiments, query conditions from a plurality of nodes may be gathered at runtime in a data structure similar that of FIG. 7B, similar to above. As indicated above, this data structure or generated code, e.g., representing the plurality of nodes, may be converted to one or more of various query language formats. As described above, an external database may execute the converted query and return information to the program.

In one embodiment, the method may also include executing the graphical program and correspondingly, executing the specified query. Thus, as indicated above with regard to FIG. 4, the query, e.g., in the graphical program, may execute according to the user input. In other words, at runtime, e.g., as part of the graphical program execution, the specified query may be invoked and/or executed to access the specified data source, e.g., to retrieve and/or modify data stored therein.

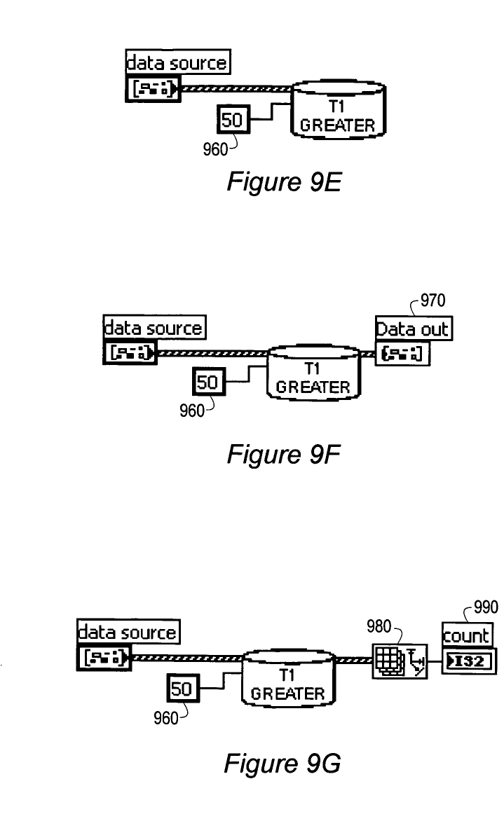

FIGS. 9A-9G—Exemplary Query Specification

FIGS. 9A-9G illustrate an exemplary specification of a query in a graphical program, according to one embodiment. More specifically, FIGS. 9A-9G illustrate an exemplary walk through of such a graphical query specification, following the example of FIGS. 4, 5A, and 5B described above. As may be seen, in FIG. 9A, the user may specify a data source of the query, e.g., data in node 910, and a where node 920, in this case set to ‘Equal’, to specify a condition for the query. In FIG. 9B, the user may connect the data source 910 to the where node 920 via a connection wire 915, e.g., using a mouse to connect the two nodes in the graphical program. In FIG. 9C, the user may select the where node, e.g., via a mouse or keyboard, to view a list 950 of available variables, e.g., as populated by the GUI from the data source 910, as well as a list of conditions, e.g., equal, greater, less, not equal, contains, not contains, and starts with. As also shown, an option is provided allowing the user to browse for other conditions. In this example, the user may select the T1 variable from the list of available variables, following the examples described above. Subsequently, in FIG. 9D, also following the examples above, the user may select the ‘greater’ condition. In FIG. 9E, the GUI may automatically generate a terminal or information input space, e.g., terminal 965, where the user may fully specify the condition; in this case, the user may enter the value ‘50’, e.g., via a keyboard coupled to the computer system, resulting in the condition “where T1 is greater than 50”.

In FIG. 9F, the user may specify an output for the query; in this case, the output may be sent to a front panel as specified by display node 970. As indicated above, FIG. 6 illustrates an exemplary front panel display. During execution of the query, e.g., in the graphical program, the front panel may display retrieved values of the query, e.g., T1 value 610, UUT value 620, and comment 630, as well as associated values, e.g., in the same data set as those retrieved according to the specified conditions of the query. In one embodiment, the front panel may scroll through, or otherwise browse, the various data sets that correspond to the values retrieved according the specified conditions. Note that the above descriptions and Figures are exemplary only, and, in fact, that other front panel displays, options, and interfaces are envisioned, e.g., such as, for example, any of various possible front panel displays, e.g., according to user specification and/or design.

Alternatively, the user may specify that the data be processed in any of various ways, such as, for example, using counting block 980, and the processed data may be subsequently displayed in a front panel display using count display node 990.

Note that the above described process for specifying and configuring the query is exemplary only, and other methods, processes, graphical displays, and orders for specifying the query are envisioned.

Thus, using the systems and methods described herein, a user may specify a query in a graphical program.

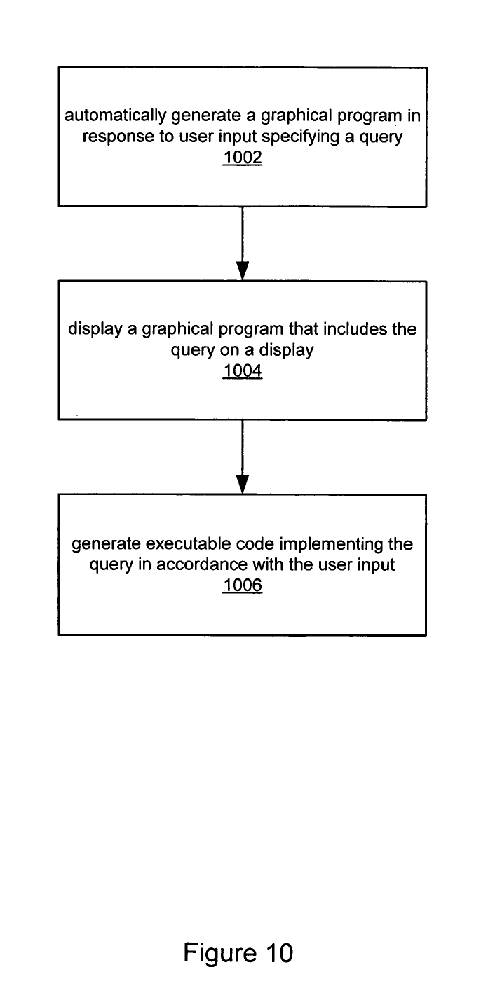

FIG. 10—Method for Specifying Queries in a Graphical Program

FIG. 10 illustrates an exemplary method for specifying queries in a graphical program. The method shown in FIG. 10 may be used in conjunction with any of the computer systems or devices shown in the above Figures, among other systems or devices. In various embodiments, some of the method elements shown may be performed concurrently, in a different order than shown, or may be omitted. Additional method elements may also be performed as desired. As shown, this method may operate as follows.

In some embodiments, other types of inputs may specify the query. For example, as shown in 1002, in one embodiment, the user may specify the query, e.g., using a higher level graphical user interface or wizard. In one embodiment, the tool or program may allow the user to specify various characteristics of the query, e.g., via a series of windows and/or a graphical wizard, and may automatically generate a graphical program that includes the query, e.g., as shown in 1004. For example, the user may specify the data source and output as well as various conditions in the windows or wizard, and the wizard may automatically configure, arrange, and/or display a plurality of connected nodes of a graphical program based on the user input. In other words, the user may specify characteristics of the query, but may not directly arrange and/or configure the nodes, e.g., as in the descriptions indicated above with regard to FIGS. 3-9.

In automatically generating a graphical program, software may operate to automatically select nodes and place nodes in the diagram, and also automatically create connections between the nodes, without user input directly selecting the nodes or configuring connections between the nodes. Thus a graphical program implementation of a query can be automatically created from high level user input, where this automatic creation of the graphical program is in contrast to manual user creation of a graphical program described in FIG. 3.

Alternatively, or additionally, the input may be received from an external program or another system coupled to the computer system, e.g., the input may be received to the computer system 82 from a program, e.g., a graphical program, executing on the computer system 90. For example, in one embodiment, a system and/or device may specify retrieval of information in a graphical program executing on the computer system, e.g., the computer system 82, and the computer system, or alternatively, the system and/or device, may generate input for the GUI to automatically specify the query, i.e., the nodes and interconnections graphically representing the query, for immediate and/or future execution. Thus, in some embodiments, the input may be received from various sources, e.g., other than the user, to configure and/or specify the query.

Similar to methods described above, the method may also include, e.g., in 1006, generating executable code and/or executing the graphical program and correspondingly the query.

Further details of systems and methods for performing the functionalities described above are described in U.S. Publication Number 2001/0020291 (Ser. No. 09/745,023), U.S. application Ser. No. 09/886,455, and U.S. application Ser. No. 09/518,492, which have been incorporated by reference above.

Note that after receiving the input, the methods described above may be applied; for example, the GUI may provide configuration or editing information to the user, generate executable code representing the graphical query, e.g., in the graphical program, and/or execute the graphical program as well as the specified query.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-accessible memory medium, wherein the memory medium comprises program instructions executable by a processor to:
receive first user input configuring a first plurality of nodes and connections between the nodes, wherein the first plurality of connected nodes specify a query; and
generate executable code implementing the specified query in accordance with the first user input.

2. The memory medium of claim 1,
wherein the first user input specifies at least a data source and an output for the query.

3. The memory medium of claim 1,
wherein the first plurality of connected nodes comprise a first portion of a graphical data flow program, wherein the connections indicate data flow among the nodes.

4. The memory medium of claim 1, wherein the first user input is received to a graphical user interface (GUI), and wherein the program instructions are further executable by the processor to:
automatically display one or more options in the GUI based on the first user input; and
receive second user input selecting at least one option of the one or more options, wherein the at least one option specifies further characteristics of the query;
wherein said generating executable code further comprises generating executable code implementing the specified query in the graphical program in accordance with the selected at least one option.

5. The memory medium of claim 1, wherein the program instructions are further executable by the processor to:
receive second user input configuring one or more nodes, wherein the one or more nodes graphically represent a condition of the query;
wherein said generating executable code further comprises generating executable code implementing the specified query in the graphical program in accordance with the condition.

6. The memory medium of claim 5, wherein the program instructions are further executable by the processor to:
receive third user input configuring at least one node of the one or more nodes, wherein the at least one node graphically represents at least a portion of a condition of the query;
automatically populate one or more lists based on the third user input and the data source for the query;
receive fourth user input selecting one or more elements from the one or more lists; and
receive fifth user input specifying one or more values corresponding to the one or more elements, wherein said fifth user input completes specification of the condition of the query.

7. The memory medium of claim 6,
wherein the at least one node comprises a graphical where node;
wherein the one or more lists comprise available variables from the data source for the query; and
wherein the one or more elements from the one or more lists comprise one or more of the available variables.

8. The memory medium of claim 5, wherein the program instructions are further executable by the processor to:
perform said receiving second user input one or more additional times to specify one or more additional conditions of the query.

9. The memory medium of claim 8, wherein the program instructions are further executable by the processor to:
receive further user input specifying an arrangement of the plurality of conditions of the query via a second plurality of nodes, wherein the plurality of conditions comprises the condition and the one or more additional conditions of the query, and wherein the second plurality of nodes graphically represent the plurality of conditions.

10. The memory medium of claim 9,
wherein the arrangement comprises one or more logical operation nodes among the second plurality of nodes graphically representing the plurality of conditions of the query.

11. The memory medium of claim 10, wherein the one or more logical operation nodes comprise one or more of:
an OR node;
a XOR node;
a NOR node;
an XNOR node;
an AND node;
a NAND node; and
a NOT node.

12. The memory medium of claim 1,
wherein the first user input specifies a type of query.

13. The memory medium of claim 12,
wherein the type of query comprises one or more of:
fetch;
delete;
count;
sum;
multiply;
divide;
update;
average;
minimum; and
maximum.

14. The memory medium of claim 1, wherein the program instructions are further executable by the processor to:
receive second user input specifying a function to eliminate duplicates in the query, wherein during execution, the query is operable to only retrieve and/or perform functions on unique entries from the data source.

15. The memory medium of claim 1, wherein the first user input is received to a GUI, wherein the first user input specifies at least a data source for the query, and wherein the data source comprises one or more of:
a memory medium comprised in a computer executing the GUI;
a memory medium coupled to the computer executing the GUI;
a database;
an extensible Markup Language (XML) file;
a structured query language (SQL) database;
an external file;
a mark-up language file;
an array; and
a Technical Data Management (TDM) file.

16. The memory medium of claim 15, wherein the program instructions are further executable by the processor to:
if the user specifies the database, automatically display a database connection window, wherein the database connection window comprises one or more available options for specifying a connection to the database.

17. The memory medium of claim 14,
wherein the output of the query comprises a visual display of results of the query.

18. The memory medium of claim 1,
wherein the query graphically represents a SQL query.

19. The memory medium of claim 1,
wherein the query is specified in a graphical program, and wherein the graphical program comprises a block diagram portion and a user interface portion.

20. The memory medium of claim 1,
wherein the query is specified in a graphical program, and wherein the graphical program is operable to perform one or more of:
an industrial automation function;
a process control function;
a test and measurement function.

21. The memory medium of claim 1, wherein the program instructions are further executable by the processor to:
execute the graphical program, wherein said executing the graphical program comprises executing the specified query.

22. The memory medium of claim 1, wherein the first user input specifies at least a data source for the query, wherein the data source comprises a file and/or a memory medium, and wherein said generating executable code comprises:
generating machine code to perform the specified query.

23. The memory medium of claim 1, wherein said generating executable code comprises:
generating a query in a query language; and
generating machine code to invoke the language specific query.

24. The memory medium of claim 23, wherein the first user input specifies at least a data source for the query, wherein the data source comprises an external database comprised in a database server, wherein the query in the query language comprises a database query in the query language, and wherein said generating executable code further comprises:
transmitting the language specific query to the database server; and
the database server performing the language specific query.

25. The memory medium of claim 24,
wherein the database query comprises a SQL database query, and wherein the database server comprises a SQL database server.

26. The memory medium of claim 24,
wherein the database query comprises an XPath query, wherein the database server comprises one or more of:
a National Instruments DataFinder component;
a National Instruments Universal Storage Interface (USI) component;
a Xerces component; or
an internet browser; and
wherein the external database comprises one or more of
a TDM file;
an XML file; or
an XML-Document Object Model (XML-DOM) file.

27. A computer-accessible memory medium, wherein the memory medium comprises program instructions executable by a processor to:
display a first graphical program on a display, wherein the first graphical program specifies a query, wherein the first graphical program comprises a plurality of nodes and connections between the nodes;
wherein the first graphical program is executable to perform the query.

28. The memory medium of claim 27, wherein the program instructions are further executable to:
generate executable code implementing the query in accordance with the first graphical program; and
execute the executable code to perform the query.

29. The memory medium of claim 27, wherein the program instructions are further executable to:
automatically generate the first graphical program in response to user input specifying the query.

30. A computer-implemented method for creating a query in a graphical program, the method comprising:
receiving first user input specifying at least a portion of a query in a graphical program, wherein the graphical program comprises a plurality of nodes and connections between the nodes, wherein the user input is received to a graphical user interface (GUI) of a graphical program development environment, wherein the first user input specifies at least a data source and an output for the query, and wherein the first user input specifies at least some of the at least a portion of the query via graphical means; and
generating executable code implementing the specified query in the graphical program in accordance with the first user input.

31. A system, comprising:
means for receiving first user input configuring a first plurality of nodes and connections between the nodes, wherein the first plurality of connected nodes specify a query;
means for generating executable code implementing the specified query in accordance with the first user input.
